(19) United States
(12) Patent Application Publication
(10) Pub. No.: US 2013/0039719 A1
(43) Pub. Date: Feb. 14, 2013

(54) TAKE DOWN NAIL/SCREW

(71) Applicant: David L. Katz, Hamden, CT (US)

(72) Inventor: David L. Katz, Hamden, CT (US)

(21) Appl. No.: 13/205,802

(22) Filed: Aug. 9, 2011

(51) Int. Cl. F16B 21/18; F16B 15/08

(52) U.S. Cl. 411/352; 411/455

(57) ABSTRACT

A fastening system for securing an object to a support includes a fastener having two shank members with one shank member being longer than the other. In a first embodiment, the fastening system is formed by a nail for securing an object to a support broadly comprises a head, a first shank having a first length, a second shank having a second length different from the first length, and the second shank being secured to the first shank. In a second embodiment, the fastening system is formed by a screw for securing an object to a support, which comprises a head, a first threaded member integrally formed with the head, a second non-threaded member having a loop portion with an aperture; and the first threaded member passing through the aperture in the loop portion.

### BACKGROUND

The present invention relates to a fastening system for securing an object to a support. The fastening system includes a first member having a first length and a second member attached to the first member having a second length. In one embodiment, the fastening system comprises a nail system having two shanks connected to each other. In a second embodiment, the fastening system comprises a screw system having one threaded member and one non-threaded member joined to each other.

Traditionally, nails having a single shank member attached to a head. To attach an object to a support, the nail is driven through the object and into the support. The head of the nail by itself secures the object to the support.

In lieu of nails, screws have been used to secure an object to a support. Typically, the object has a hole into which the screw is threaded. Depending on the support, the support may be provided with a pre-drilled hole into which the tip of the screw enters or alternatively, the screw is threaded into the support.

Such nails and screws are ineffective to hold certain objects, such as a wire or mesh structure, to a support, such as a post or beam.

### SUMMARY OF THE INVENTION

It is an object of the present invention to provide a fastening system which broadly comprises a fastener having two shank members with one shank member being longer than the other.

In a first embodiment, the fastening system is formed by a nail for securing an object to a support broadly comprising a head, a first shank having a first length, a second shank having a second length different from the first length, and the second shank being secured to the first shank.

In a second embodiment, the fastening system is formed by a screw for securing an object to a support, broadly comprising a head, a first threaded member integrally formed with the head, a second non-threaded member having a loop portion with an aperture, and the first threaded member passing through the aperture in the loop portion.

Other details of the take down nail/screw of the present invention are set forth in the following detailed description and the accompanying drawings wherein like reference numerals depict like elements.

### BRIEF DESCRIPTION OF THE DRAWINGS

FIG. 1 is a schematic representation of a nail in accordance with the present invention;

FIG. 2 is a schematic representation of the nail of FIG. 1 securing an object to a support;

FIG. 3 is a schematic representation of a screw in accordance with the present invention; and

FIG. 4 is a schematic representation of the screw of FIG. 3 securing an object to a support.

### DETAILED DESCRIPTION OF THE PREFERRED EMBODIMENT(S)

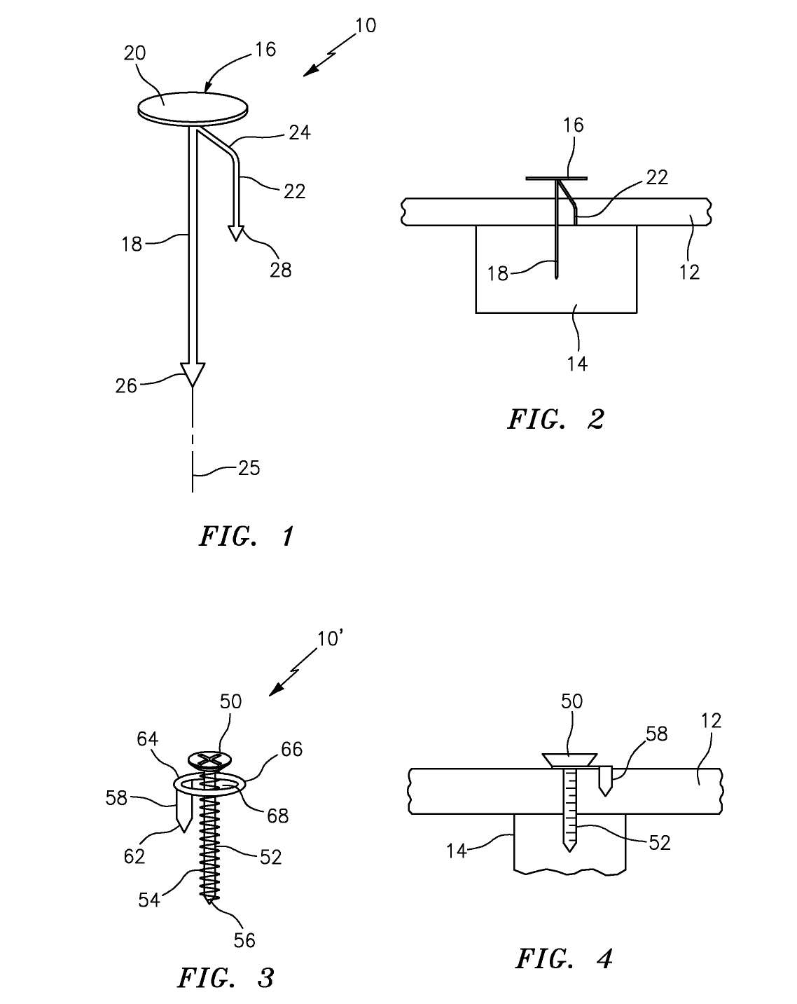

Referring now to FIGS. 1 and 2, there is shown a first embodiment of a fastening system 10 for securing an object 12, such as wire, plasterboard, a cable, or a mesh element, to a support 14, such as a post or a beam. The fastening system 10 comprises a nail having a head 16 and a first shank member 18 integrally formed with the head 16. The head 16 may have any desired shape, such as a circular shape. Further, the head 16 has an upper surface 20 which is flat so that it can be struck by a driver (not shown) such as a hammer or a power driver. Integrally formed with the first shank member 18 is a second shank member 22 which preferably extends parallel to the first shank member 18. The second shank member 22 is joined to the first shank member 18 by an integrally formed angled portion 24. The angled portion 24 may be at any desired angle with respect to a longitudinal axis 25 of the first shank member 18 so as to create any desired spacing between the first and second shank members 18 and 22. For example, the angled portion 24 may be at a right angle with respect to the longitudinal axis of said first shank member 18 or may be at an angle less than 90 degrees with respect to the longitudinal axis of said first shank member.

As can be seen from FIG. 1, the first shank member 18 has a first length and the second shank member 22 has a second length which is different from the first length. Typically, the second length is shorter than the first length.

Each of the shank members 18 and 22 has a tip 26 and 28 respectively. Each tip 26 and 28 has a point 32 and 34 respectively, which allows the shank members to be driven into a support 14 and/or an object 12. If desired, each of the shank members 18 and 22 may be tapered from a first end to their respective tip 26 or 28. Alternatively, each of the shank members 18 and 22 may have a constant diameter from the first end to their respective tips 26 or 28.

The nail including the head 16, the first shank member 18, the angled portion 24, and the second shank member 22 may be formed from any suitable material known in the art.

As shown in FIG. 2, the nail may be used to attach a section of a wire, a mesh element, a cable, or plasterboard 12 to a post 14. By providing the nail with the two different shank member lengths, one can drive the first shank member 18 deeply into the support and the second shank member 22 over and through the object 12 and if desired into the underlying support 14.

The nail described herein has greater strength than fasteners such as staples and a greater ease of use as compared to large U-shaped nails. The nail described herein drives like a standard nail adjacent to the object 12. The second shank member 22 then takes it down into the foundation material. The nail described herein is particularly useful when it becomes necessary to replace the object 12. By having such a nail one can remove/replace the object 12 without removing all of the first shank member 18 from the support 14. Additionally, by using the nail of the present invention, due to the separation between the first and second shank members 18 and 22, one is able to support a wider portion of the object 12 with a single nail.

Referring now to FIGS. 3 and 4, there is shown a second embodiment of a fastening system in accordance with the present invention. The fastening system 10′ comprises a screw system having a head 50 and an integrally formed first shank member 52 having any desired thread pattern 54 and a pointed end 56. The screw system further comprises a second shank member 58 extending parallel to the first shank member 52. The second shank member 58 is not threaded. The second shank member has a pointed end 62. At the end 64 opposed to the pointed end 62, there is an integrally formed loop portion 66 with an aperture 68. The aperture 68 is sized so that the loop portion 66 fits over the first shank member 52. The loop portion 66 has an external diameter which is sized so that the loop portion can be contacted by an outer portion of the head 50. A portion of the first shank member 52 is received within the aperture 68. During use, the screw turns, but the second shank member 58 does not.

As can be seen from FIG. 3, the first shank member 52 has a first length and the second shank member 58 has a second length different from the first length. In a preferred embodiment, the first length is greater than the second length.

The head 50 may be provided with either a straight groove or a Phillips head groove for receiving a driving implement such as a screw driver or a powered tool.

As shown in FIG. 4, the screw with the first shank member 52 may be driven into a support 14. As the screw is rotated, the second shank member 58 is pulled over the object 12 to be clasped and drives the object 12 against the support 14. Material strands from the object 12 may run between the shaft of the first shank member 52 and the second shank member 58.

The first and second shank members 52 and 58 may be manufactured separately or may be integrally formed. Further, the shank members 52 and 58 may be formed from any suitable material known in the art. Still further, the distance between the two shank members 52 and 58 may be selected to allow for the pinning down of lighter/thinner, or heavier thicker materials.

In accordance with the present invention, there has been provided a take down nail/screw which fully satisfies the objects, means and advantages set forth hereinbefore. While the present invention has been described in the context of specific embodiments thereof, other unforeseen alternatives, modifications, and variations may fall within the broad scope of the appended claims. Accordingly, it is intended to embrace those alternatives, modification and variations as fall within the broad scope of the appended claims.

What is claimed is:

1. A nail for securing an object to a support comprising:
a head;
a first shank having a first length attached to said head; and
a second shank spaced from said first shank, said second shank having a second length different from said first length; and
an angled portion for attaching said second shank to said first shank.

2. The nail of claim 1, wherein said first length is greater than said second length.

3. The nail of claim 1, wherein said head is circular in shape and has a flat upper surface.

4. The nail of claim 1, wherein said second shank extends parallel to said first shank.

5. The nail of claim 1, wherein said first shank has a longitudinal axis and said angled portion extends at a right angle with respect to said longitudinal axis.

6. The nail of claim 1, wherein said first shank has a longitudinal axis and said angled portion extends at an angle less than ninety degrees with respect to said longitudinal axis.

7. The nail of claim 1, wherein both said first shank and said second shank have a pointed end.

8. The nail of claim 7, wherein said first shank tapers from a first end attached to said head to said pointed end.

9. The nail of claim 7, wherein said second shank tapers from a first end to said pointed end.

10. A screw for securing an object to a support, comprising:
a head;
a first threaded member integrally formed with said head;
a second non-threaded member having a loop portion with an aperture; and
a portion of said first threaded member passing through said aperture in said loop portion.

11. The screw of claim 10, wherein said first threaded member has a first length and said second non-threaded member has a second length different from said first length.

12. The screw of claim 11, wherein said first length is greater than said second length.

13. The screw of claim 10, wherein said head has a single groove.

14. The screw of claim 10, wherein said head has a Phillip's head groove.

15. The screw of claim 10, wherein said first threaded member has a pointed end.

16. The screw of claim 10, wherein said second non-threaded member has a pointed end.

17. A fastening system for securing an object to a support comprising:
a fastener having a first member having a first length and a pointed end;
a second member having a second length and a pointed end; and
said second member extending parallel to said first member and being spaced from said first member by a distance.

18. The fastening system of claim 17, wherein said fastener comprises a nail having a head and said first member comprises a first shank integrally formed with said head.

19. The fastening system of claim 18, wherein said second member is joined to said first member by an angled portion and said first length is greater than said second length.

20. The fastening system of claim 17, wherein said fastener comprises a screw having a head, said second member comprises a non-threaded member having an integrally formed loop portion with an aperture, and a portion of said screw passes through said aperture in said loop portion.
